(19) United States
(12) Patent Application Publication
(10) Pub. No.: US 2014/0098226 A1
(43) Pub. Date: Apr. 10, 2014

(54) IMAGE CAPTURE COMPONENT ON ACTIVE CONTACT LENS

(71) Applicant: Google Inc., Mountain View, CA (US)

(72) Inventors: Nathan Pletcher, Mountain View, CA (US); Babak Amirparviz, Mountain View, CA (US); Olivia Hatalsky, Berkeley, CA (US)

(21) Appl. No.: 13/647,348

(22) Filed: Oct. 8, 2012

(51) Int. Cl. G06K 9/78; H04N 7/18

(52) U.S. Cl. 348/143; 382/103; 348/E07.085

(57) ABSTRACT

This disclosure relates to systems and/or methods for capturing image data representing a scene in a gaze of a viewer via a thin image capture component integrated on or within a contact lens, processing the image data, and employing the processed image data to perform functions locally on the contact lens or remotely on one or more remote devices.

### TECHNICAL FIELD

This disclosure generally relates to systems and/or methods for capturing image data representing a scene in a gaze of a viewer via a thin image capture component integrated on or within a contact lens, processing the image data, and employing the processed image data to perform functions locally on the contact lens or remotely on one or more remote devices.

### BRIEF DESCRIPTION OF THE DRAWINGS

FIG. 1A illustrates a diagram of an exemplary non-limiting system for capturing images corresponding to a scene in the gaze of a wearer of a contact lens in accordance with an implementation of this disclosure.

FIG. 1B illustrates a diagram of the exemplary non-limiting system of FIG. 1A worn on both eyes of a human user in accordance with an implementation of this disclosure.

FIG. 2A illustrates a diagram of an exemplary non-limiting contact lens from FIG. 1A in accordance with an implementation of this disclosure.

FIG. 2B illustrates a diagram of an exemplary non-limiting example close-up view of contact lens from FIG. 1A in relation to an eye in accordance with an implementation of this disclosure.

FIG. 2C illustrates a diagram of an exemplary non-limiting pair of contact lenses for providing a wider peripheral view than a pair of eyes can generally achieve in accordance with an implementation of this disclosure.

FIG. 2D illustrates a diagram of an exemplary non-limiting image capture component for converting light into electrical signals corresponding to an image represented by the light in accordance with an implementation of this disclosure.

FIG. 2E illustrates a diagram of an exemplary non-limiting control circuit for capturing images corresponding to a scene in the gaze of a wearer of a contact lens in accordance with an implementation of this disclosure.

FIG. 3A illustrates a diagram of an exemplary non-limiting scene of a tree captured by the contact lens of FIG. 1A in accordance with an implementation of this disclosure.

FIG. 3B illustrates a diagram of an exemplary non-limiting scene of an intersection captured by the contact lens of FIG. 1A in accordance with an implementation of this disclosure.

FIG. 4 illustrates an exemplary non-limiting flow diagram for capturing images corresponding to a scene in the gaze of a wearer of a contact lens in accordance with an implementation of this disclosure.

FIG. 5 is a block diagram representing an exemplary non-limiting networked environment in which the various embodiments can be implemented.

FIG. 6 is a block diagram representing an exemplary non-limiting computing system or operating environment in which the various embodiments can be implemented.

### DETAILED DESCRIPTION

### Overview

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of this disclosure may be practiced without these specific details, or with other methods, components, materials, etc. In other instances, well-known structures and devices are shown in block diagram form to facilitate describing this disclosure.

In accordance with various disclosed aspects, a contact lens with an outward facing image capture component is provided for generating image data corresponding to an image of a scene in a gaze of a wearer of the contact lens. For example, a thin image capture component can be embedded on or within a contact lens such that it does not substantially affect thickness of a conventional contact lens. Furthermore, the image capture component can be aligned such that it tracks and generates image data of an image of a scene corresponding to gaze of the wearer, without obstructing the wearer's view. As the wearer's gaze shifts, the contact lens will follow the shift in gaze, thereby allowing for generating image data corresponding to an image of the scene in the shifted gaze. Additionally, the image data can be processed to detect light, colors, pattern of colors, objects, faces, motion, or any other suitable information that can be derived from processing one or more images. It is to be appreciated that components on or within a contact lens can be of a shape, size, opacity, and/or positioned so as not to obstruct vision through an opening of a pupil of an eye when worn.

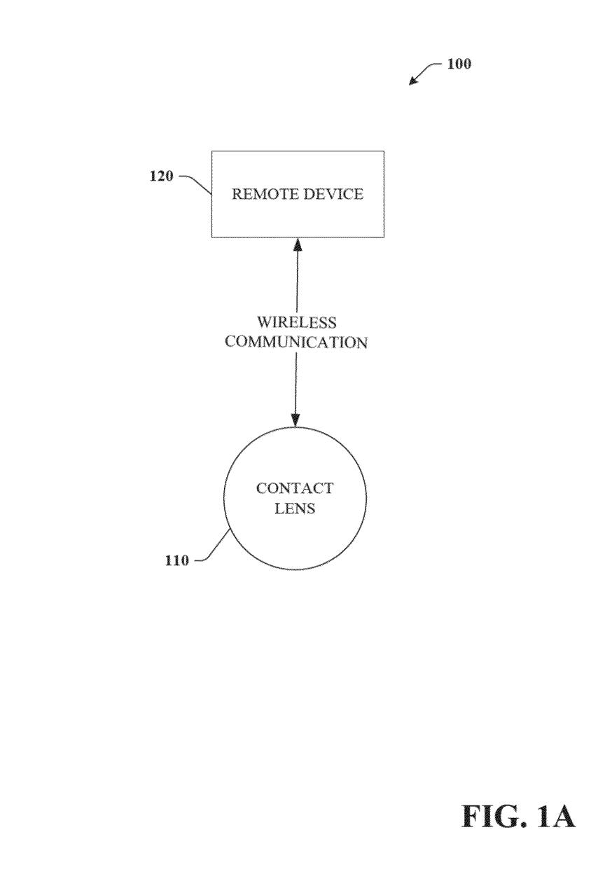

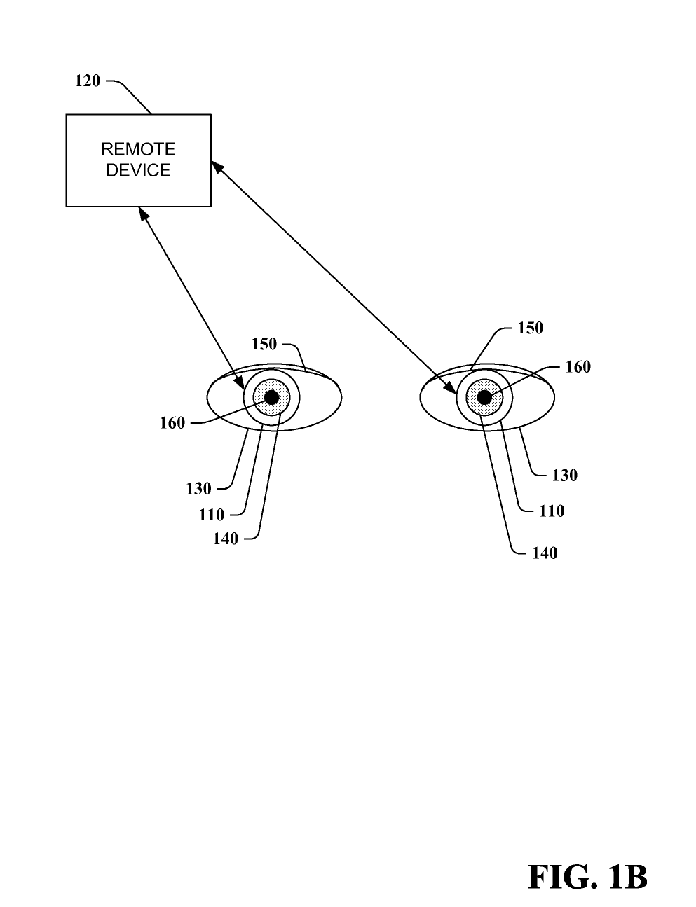

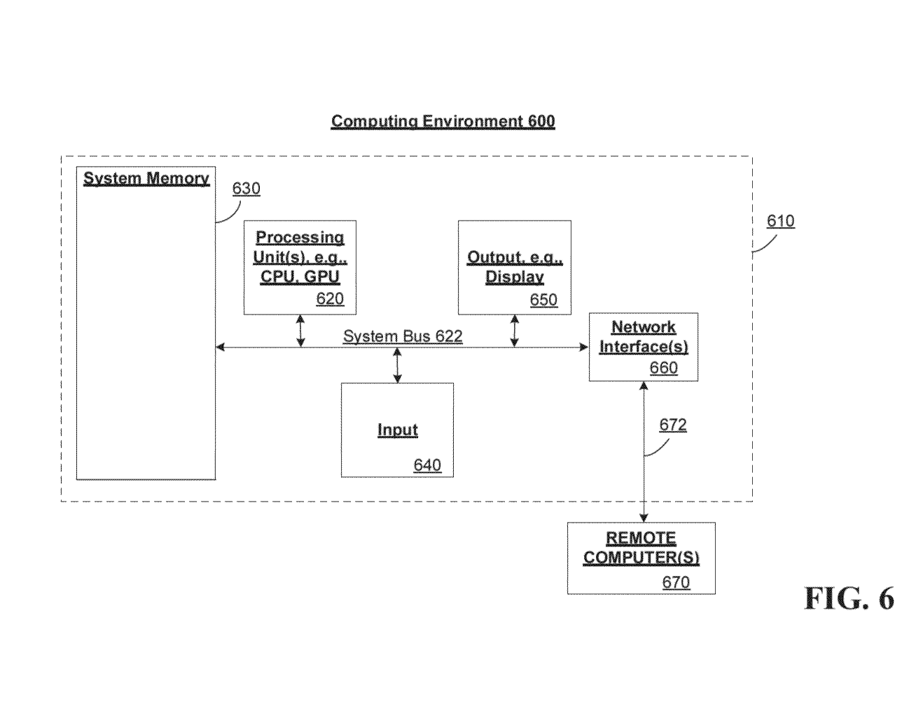

Referring now to the drawings, FIG. 1A depicts a system 100 for generating information corresponding to an image of a scene in a gaze of a wearer of a contact lens. System 100 includes a contact lens 110 that generates information related to gaze of a wearer of a contact lens (hereinafter referred to as “image information”). In addition, contact lens 110 can utilize the image information locally to control features of contact lens 110 (e.g., analyzing image information, issuing commands, adjusting content presentation, activating or deactivating options or components (e.g., warning LED indicators), or any other suitable function). Furthermore, contact lens 110 can communicate image information to a remote device 120 for employment in connection with operations associated with the remote device 120 (e.g., analyzing image information, adjusting content presentation, activating or deactivating options or components (e.g., an audible warning), requesting instructions or information, issuing commands, or any other suitable function). Contact lens 110 and remote device 120 can also receive input from users, for example to control interaction with and presentation of content, or operation of contact lens 110 or remote device 120, see e.g., FIG. 6 and corresponding disclosure.

Contact lens 110 and remote device 120, respectively include a memory that stores computer executable components and a processing circuit, which can include a processor, that executes computer executable components stored in the memory (see e.g., FIG. 6). Contact lens 110 and remote device 120 can communicate via a wireless network. It is to be appreciated that while only one remote device 120 is depicted, contact lens 110 can communicate with any suitable number of remote devices 120 concurrently, serially, an ad hoc manner, or in accordance with any suitable protocol. Additionally, remote device 120 can communicate with any suitable number of contact lenses 110 concurrently, serially, an ad hoc manner, or in accordance with any suitable protocol.

Remote device 120, can include a wearable device or a non-wearable device. Wearable device can include, for example, headphones, heads-up display glasses, a monocle, eyeglasses, sunglasses, a headset, a visor, a cap, a helmet, a mask, a headband, clothing, or any other suitable device that can be worn by a human or non-human user and can communicate with contact lens 110 remotely. Non-wearable device can include, for example, a mobile device, a mobile phone, a camera, a camcorder, a video camera, personal data assistant, laptop computer, tablet computer, desktop computer, server system, cable set top box, satellite set top box, cable modem, television set, monitor, media extender device, blu-ray device, DVD (digital versatile disc or digital video disc) device, compact disc device, video game system, portable video game console, audio/video receiver, radio device, portable music player, navigation system, car stereo, or any suitable device that can communicate with a contact lens 110 remotely. Moreover, remote device 120 and contact lens 110 can include a display and/or user interface (e.g., a web browser or application), that can generate, receive and/or present graphical indicia (e.g., displays, text, video . . . ) generated locally or remotely.

Referring to FIG. 1B, system 100 is depicted on a human user. Contact lenses 110 are shown worn on both eyes 130, covering irises 140 while eyelids 150 are open. Remote device 120 is shown with one or more transceivers (not shown) arranged to communicate wirelessly with contact lenses 110. It is to be further appreciated that respective transceivers of remote device 120 can have transmission power and/or signal reception sensitivity suitable for transmitting a signal to and/or receiving a signal from an associated contact lenses 110 on an eye without interfering with another contact lenses 110 on another eye. While FIG. 1B depicts a contact lenses 110 arrangement in both eyes, it is to be appreciated that an arrangement with a contact lens 110 on one eye can be employed. For example, both eyes of a human user generally track each other. As such, a single contact lens 110 can be worn to generate image information of a scene in the gaze of the viewer. In another example, two contact lenses 110 can be worn to generate three dimensional image information of the scene.

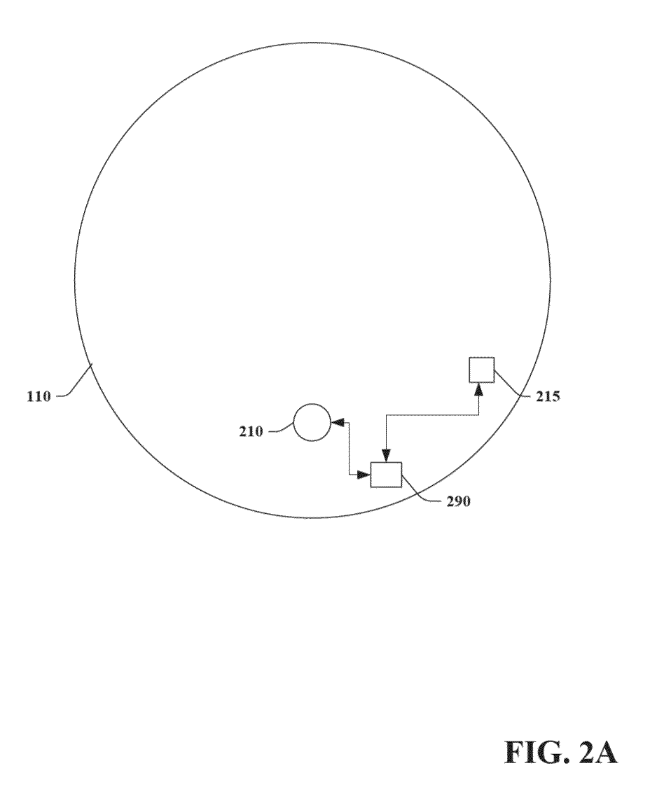

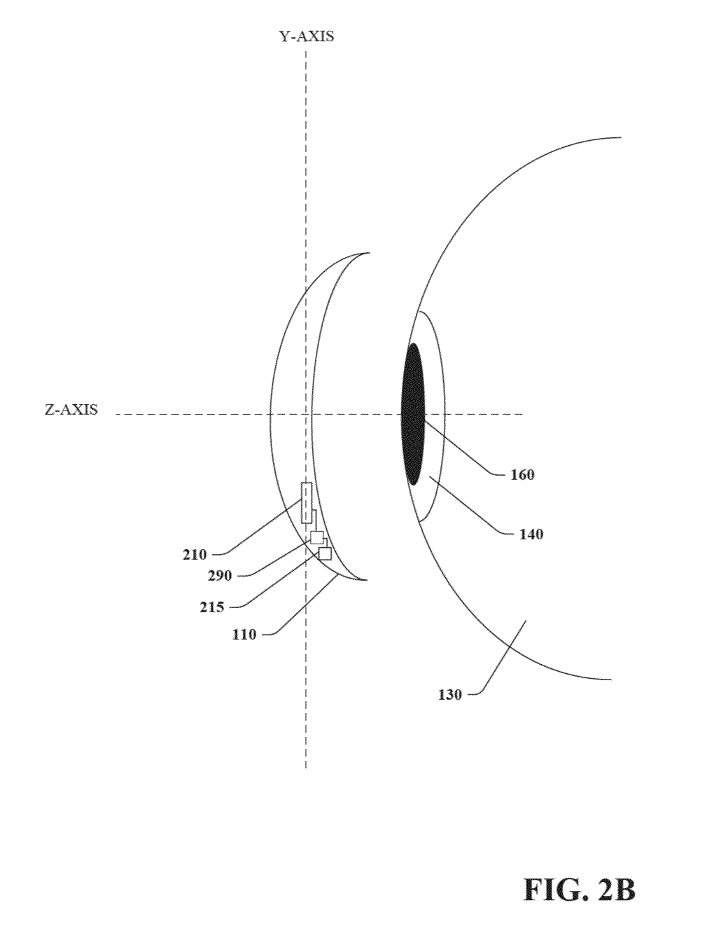

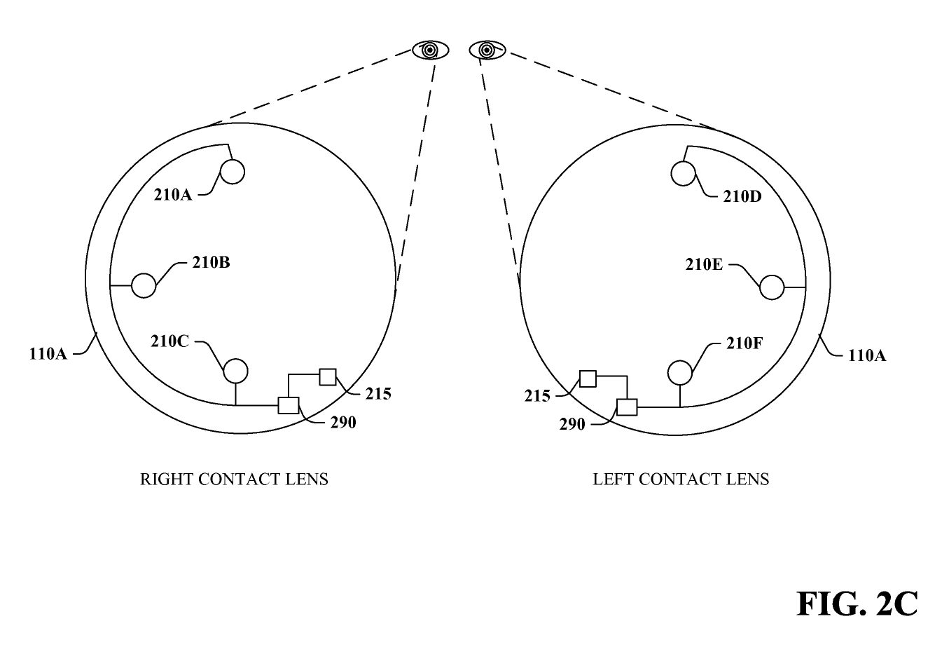

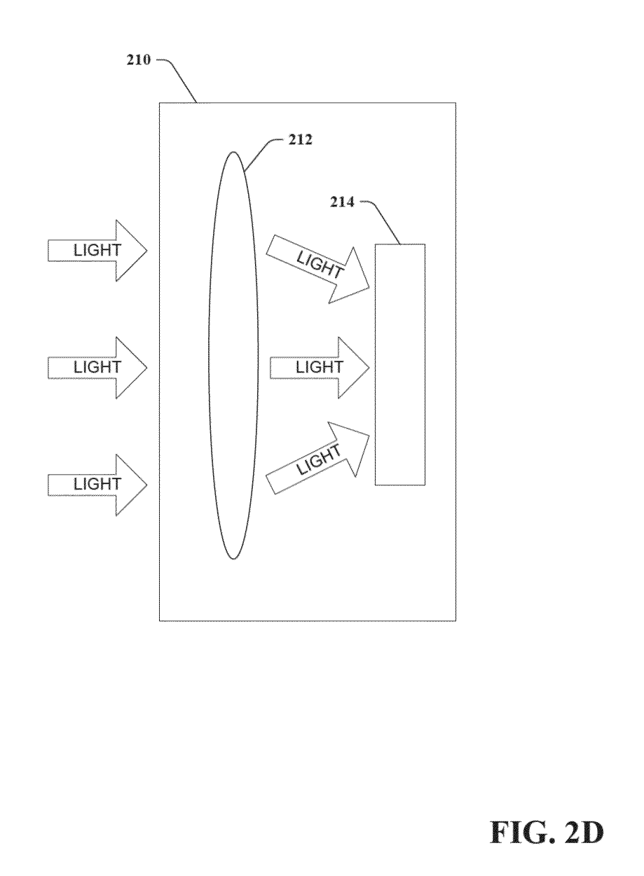

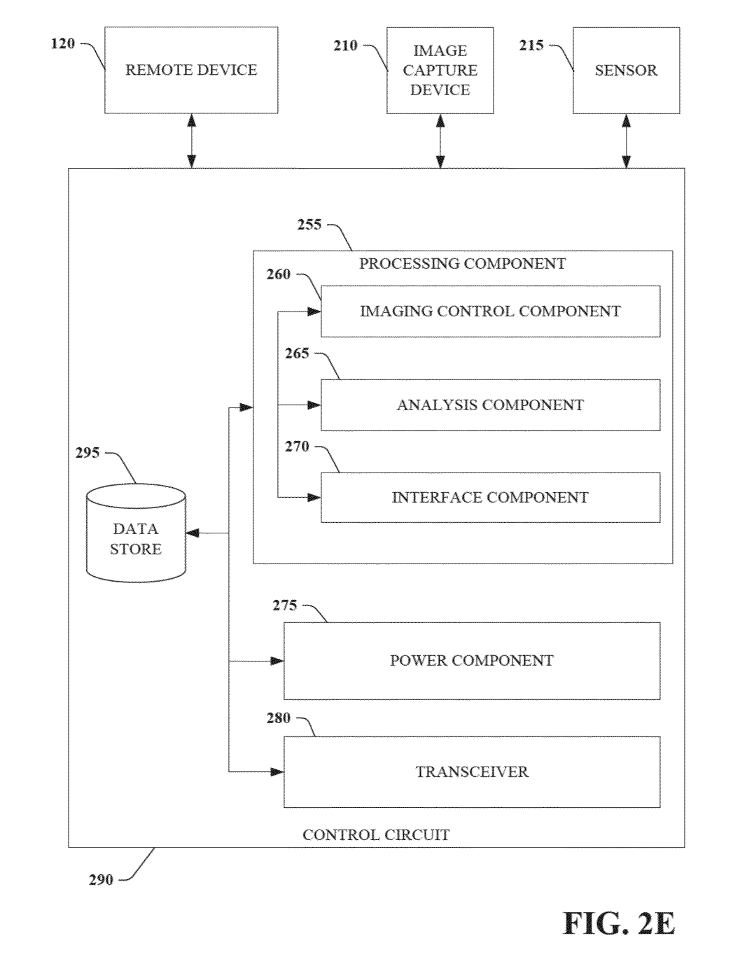

Referring to FIG. 2A, contact lens 110 is depicted that includes, disposed on or within its substrate, a control circuit 290, image capture component 210, and sensor 215. It is to be appreciated that while only one image capture component 210 and sensor 215 are depicted, any number of image capture components 210 and sensors 215 can be employed. Control circuit 290 is coupled wirelessly or via wire to image capture component 210 and sensor 215. It is to be further appreciated that different aspects of interaction between control circuit 290, and image capture component 210 and sensor 215 may be respectively coupled via wire or wirelessly. In one example, all interactions are coupled via wire. In a further example, some interactions are coupled wirelessly, while other interactions are coupled via wire. For example, communication interaction may be coupled wirelessly, while power supply interactions may be coupled via wire. Sensor 215 can be any suitable sensor for capturing energy wirelessly or mechanically. For example, sensor 215 can be a photodiode, a pressure sensor, a conductivity sensor, a temperature sensor, an electric field sensor, or a micromechanical switch. It is to be appreciated that image capture component 210 and sensor 215 can respectively be uniquely identifiable to control circuit 290, for example, via an identifier signal or identifying information conveyed respectively from image capture component 210 and sensor 215 to control circuit 290. It is also to be appreciated that control circuit 290, image capture component(s) 210, and sensor(s) 215 can be located at any suitable locations of contact lens 110.

Referring to FIG. 2B, a non-limiting example close-up view of contact lens 110 in relation to eye 130 is depicted. Contact lens 110 when worn covers iris 140 and pupil 160. The z-axis is aligned with a central axis of an outward looking gaze of eye 130. Stated another way, the z-axis can be aligned at a geometric center of pupil 160 and orthogonal to a two-dimensional plane corresponding to an image captured by eye 130. In an embodiment, image capture component 210 can face outward from eye 130 and be aligned orthogonal to the z-axis when contact lens 110 is worn on eye 130. Accordingly, images captured from image capture component 210 closely correspond to outward looking gaze of eye 130, however, with some offset corresponding to distance of image capture component 210 from the geometric center of pupil 140. It is to be appreciated that image capture component 210 can be aligned in other directions with respect to the wearer's gaze. For example, multiple image capture components 210 can be arranged around a periphery of contact lens 110 having directions angled such that they capture images providing greater peripheral vision than the wearer's eye can capture. In an embodiment, contact lens 110 can be weighted to self-align into a particular position when worn, similar to toric contact lenses.

Referring to FIG. 2C, a non-limiting example pair of contact lens 110A-B for providing a wider peripheral view than an eye 130 can generally achieve is illustrated. Right contact lens 110A can have image capture components 210 arranged at a right periphery of right contact lens 110A and left contact lens 110B can have image capture components 210 arranged at a left periphery of left contact lens 110B to provide a wider peripheral vision by capturing images to present on respective displays (not shown) embedded on or within respective right and left contact lenses 110A-B visible to the wearer. Advantageously, the wearer of right and left contact lenses 110A-B can perceive a wider angle of a scene than they would normally perceive through his/her eyes 130 alone. With respect to right contact lens 110A, image capture component 210A can be angled slightly upward and/or to the right of the wearer, image capture component 210B can be angled slightly to the right of the wearer, image capture component 210C can be angled slightly downward and/or to the right of the wearer. Likewise, with respect to right contact lens 110A, image capture component 210D can be angled slightly upward and/or to the left of the wearer, image capture component 210E can be angled slightly to the left of the wearer, image capture component 210D can be angled slightly downward and/or to the left of the wearer. In an embodiment, respective angles of image capture components 210A-F can be set to achieve a wider peripheral vision than an average human user achieves through his/her eyes 130. In another embodiment, respective angles of image capture components 210A-F can be customized to a wearer to achieve a wider peripheral vision, such as based upon a measured a peripheral vision that the wearer achieves through his/her eyes 130. It is to be appreciated that respective right and left contact lenses 110A-B need to be correctly aligned when worn so that the image capture components 210 are positioned correctly, such as by weighting as discussed above. While FIG. 2C depicts right and left contact lens 110A-B having the same number of image capture components 210 and sensors 215, it is to be appreciated that respective right and left contact lens 110A-B can have differing amounts and configurations of image capture components 210 and sensors 215.

Referring to FIG. 2D, is depicted a non-limiting example of image capture component 210 for converting light entering image capture component 210 into electrical signals corresponding to an image represented by the light. Light entering image capture component 210 is focused by focusing component 212 onto digital imager component 214. Digital imager component 214 converts light into electrical signals and to digital data corresponding to an image represented by the light (hereafter referred to as “raw image data”). In an embodiment, digital imager component 214 includes a complementary metal-oxide-semiconductor (CMOS) image sensor. In another embodiment, digital imager component 214 includes a charge-coupled device (CCD) image sensor. Digital imager component 214 can be any suitable image sensor that converts light to digital data.

Continuing with reference to FIG. 2D, focusing component 212 can be a diffractive, refractive, or hybrid diffractive-refractive focusing component of any suitable shape or size. A diffractive focusing component is generally thinner than an equivalent refractive focusing component, however, the equivalent refractive focusing component will generally have better optical performance than the diffractive focusing component. In an embodiment, focusing component 212 is a Fresnel lens, which is a type of diffractive focusing component that allows for a very thin lens at expense of reduced image quality. In another embodiment, focusing component 212 is a thin variable focus lens with a refractive index that can be altered electronically, such as a liquid crystal lens. A liquid crystal lens comprises several layers of one or more materials, including at least one liquid crystal inside layer with a refractive index that can be changed by the application of an electronic signal, such as voltage, thereby altering the focal length of the lens amongst a plurality of focal lengths. It is to be appreciated that employing focusing component 212 comprised of thinner materials advantageously can allow for constructing a contact lens 110, with an image capture component 210, that is substantially similar in thickness to conventional contact lenses worn for vision correction.

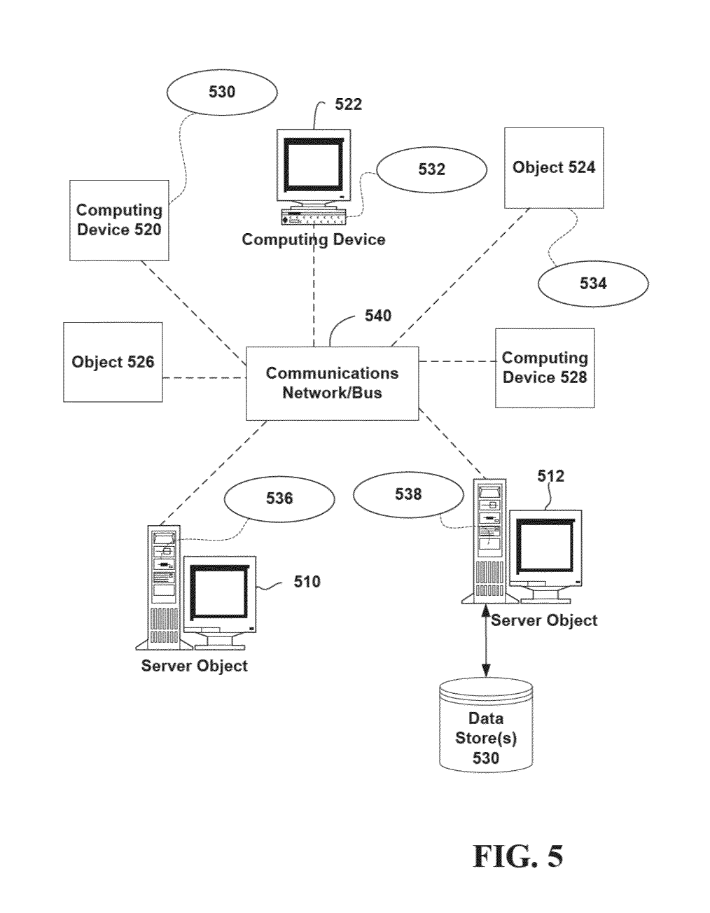

Referring to FIG. 2E, is depicted control circuit 290 that includes processing component 255 that generates image information corresponding to scenes in a gaze of a wearer of contact lens 110, and communicates with remote device 120, image capture component 210, and sensor 215. In addition, control circuit 290 can include power component 275 that manages, receives, generates, stores, and/or distributes usable electrical power to other components of contact lens 110. Control circuit 290 can also include one or more transceivers 280 for transmitting or receiving signals to or from remote device 120, image capture component 210, or sensor 215. It is to be appreciated that image capture component 210 or sensor 215 may interface directly with processing component 255 without need to employ transceiver 280, for example through a wired coupling. Additionally, control circuit 290 can include a data store 295 that can store data from processing component 255, power component 275, transceiver 280, remote device 120, image capture component 210, or sensor 215. Data store 295 can reside on any suitable type of storage device, non-limiting examples of which are illustrated with reference to FIGS. 5 and 6, and corresponding disclosure.

With continued reference to FIG. 2E, processing component 255 includes imaging control component 260 that instructs image capture component 210 when and/or how to capture raw image data corresponding to light entering image capture component 210. In an embodiment, imaging control component employs an image capture criteria in determining to instruct image capture component 210 to capture raw image data. In a non-limiting example, image capture criteria can include, a regular time interval, a random time interval, a command from a remote device, an amount of useable electric power available in contact lens 110, a signal from sensor 215 (e.g. predetermined pattern of detected blinks), rolling shutter, global shutter, exposure time, focus, auto-focus, or any other suitable criteria for instructing image capture component 210 to capture raw image data. For example, imaging control component 260 can instruct image capture component 210 to capture raw image data when an amount of usable useable electric power available in contact lens 110 meets a first threshold and to stop capturing raw image data when the amount of usable useable electric power available in contact lens 110 meets a second threshold. In this manner, power usage can be managed on contact lens 110. It is to be appreciated that a threshold can be any suitable condition, for example, a greater than condition, less than condition, equal to condition, one or more ranges, or function. In another embodiment image capture component 210 can continuously or periodically at predetermined intervals capture raw image data, thereby not requiring instructions from imaging control component 260. It is to be appreciated that any suitable interval for capturing raw image data can be employed. Processing component 255 receives raw image data from image capture component 210.

Continuing with reference to FIG. 2E, analysis component 265 can process raw image data captured at one or more instances of time from one or more contact lenses 110 to produce processed image data. Processed image data can be any suitable information derived from raw image data. In an embodiment, analysis component 265 processes the raw image data into processed image data, for example, including one or more images meeting a predefined size, resolution, fields, color palette, luminance, contrast, chrominance, brightness, frame rate, quantization, interlaced, progressive, aspect ratio, pixel density, bit rate, compression, dimensions, angles, views, or any other suitable parameter. In another embodiment, analysis component 265 processes the raw image data into processed image data including metadata about detected objects, faces, colors, patterns of color, light, motion, or any other suitable information that can be detected from raw image data. Furthermore, analysis component 265 can process the raw image data into processed image data to determine (or infer) focus parameters for imaging control component 260 to employ in instructing image capture component 210 to adjust focus of focusing component 212.

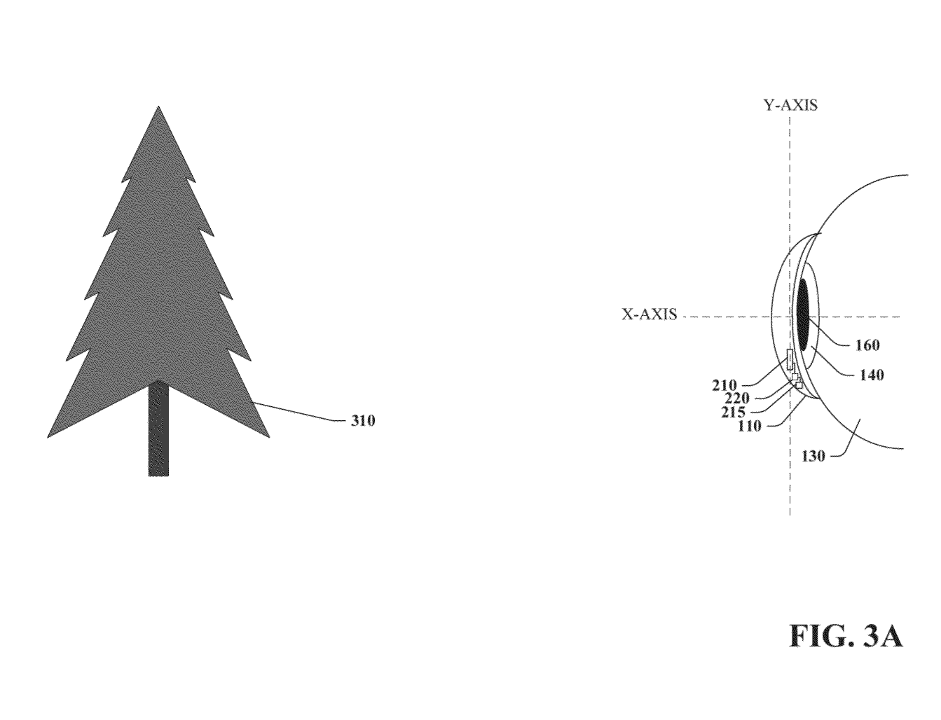

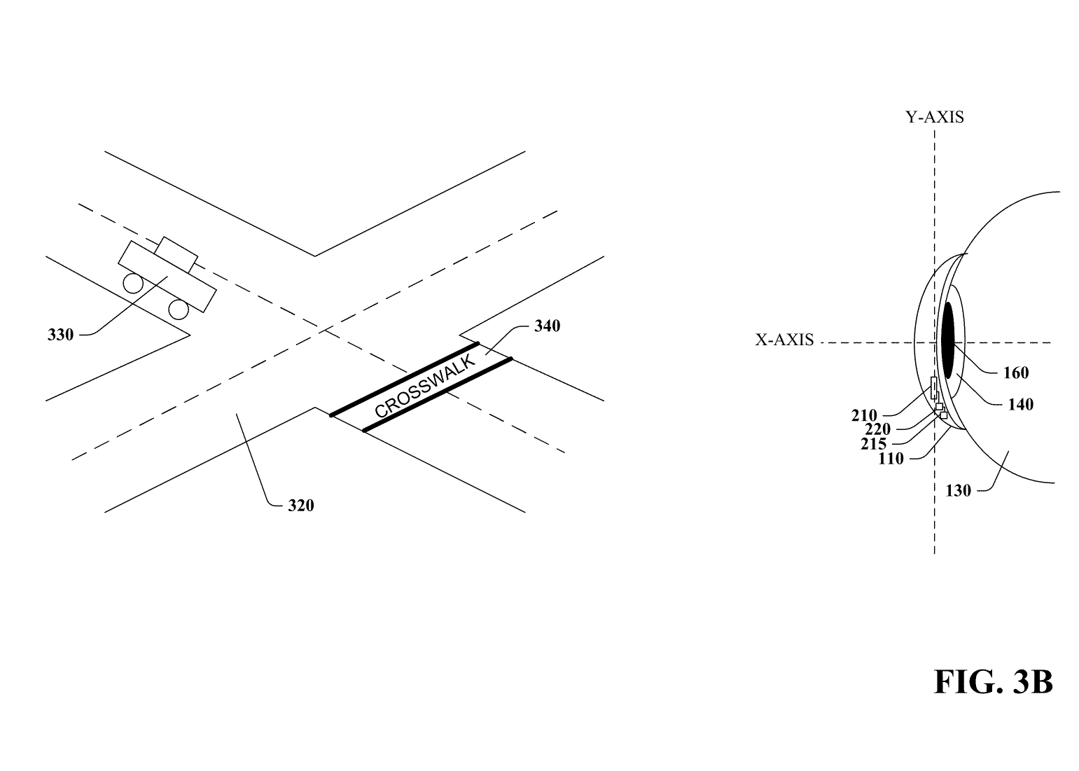

Referring to FIG. 3A, in a non-limiting example, processing component 255 can receive raw image data from image capture component 210 corresponding to tree 310 in the gaze of eye 130. Analysis component 265 can process the raw image data to determine processed image data that the object has green and brown colors, and is shaped like a tree.

Referring to FIG. 3B, in a non-limiting example, processing component 255 can receive raw image data from image capture component 210 corresponding to scene of an intersection 320 and car 330 in the gaze of eye 130. For example, a blind person wearing contact lens 110 may be walking on a sidewalk and approaching intersection 320. Analysis component 265 can process the raw image data to determine processed image data indicating that the blind person is approaching intersection 320 with crosswalk 340 and establish that there is a car 330 near intersection 320. Furthermore, analysis component 265 can process raw image data over several instances of time to determine processed image data indicating whether the car is in motion and approaching the crosswalk. Processing component can communicate the processed image data or a command to a remote device 120, such as a mobile phone, which can provide an audible warning to the blind person related to the states of intersection 320, car 330, and crosswalk 340. For example, remote device can provide a voice generated warning that crosswalk 340 is not safe to cross. In another example, for a person that is not blind, processed image data can be presented on a display integrated into contact lens 110, such as highlighting of car 330 in motion approaching crosswalk 340, a warning light emitting diode (LED), a wider peripheral view of the scene in FIG. 3B, or any other suitable presentation of processed image data.

It is to be appreciated that some or all operations of analysis component 265 are optional. For example, raw image data can be communicated to remote device 120 which can perform some or all of the operations of analysis component 265. Furthermore, processed image data can be communicated from remote device 120 to contact lens 110, for example to control features of contact lens 110 (e.g., issuing commands, adjusting content presentation, activating or deactivating options or components (e.g., warning LED indicators), or any other suitable function).

Continuing with reference to FIG. 2E, interface component 270 can communicate image information (e.g., raw image data, processed image data, or commands related to raw image data or processed image data) to remote device 120 using one or more transceivers 280. Furthermore, interface component 270 can receive data or commands from remote device 120 using the one or more transceivers 280. For example, interface component 270 can receive a request for image information from remote device 120 and respond to the request with image information. In another example, interface component 270, can receive a command from remote device 120 for imaging control component 260 to instruct image capture component 210 to capture raw image data. In a further example, analysis by remote device 120 of image information can indicate a problem and remote device 120 can send a command to interface component 270 for processing component 255 to present a warning indication or message on a display integrated into contact lens 110.

Power component 275 can include any suitable power source that can manage, receive, generate, store, and/or distribute necessary electrical power for the operation of various components of multi-sensor contact lens 110. For example, power component 275 can include but is not limited to a battery, a capacitor, a solar power source, radio frequency power source, electrochemical power source, temperature power source, or mechanically derived power source (e.g., MEMs system). In another example, power component 275 receives or generates usable electrical power from signals from one or more sensors (e.g., photodiode, pressure, heat, conductivity, electric field, magnetic, electrochemical, etc.) integrated into contact lens 110. Transceiver 280 can transmit and receive information to and from, or within contact lens 110. In some embodiments, transceiver 280 can include an RF antenna.

It is to be appreciated that in accordance with one or more implementations described in this disclosure, users can opt-in or opt-out of providing personal information, demographic information, location information, proprietary information, sensitive information, or the like in connection with data gathering aspects. Moreover, one or more implementations described herein can provide for anonymizing collected, received, or transmitted data.

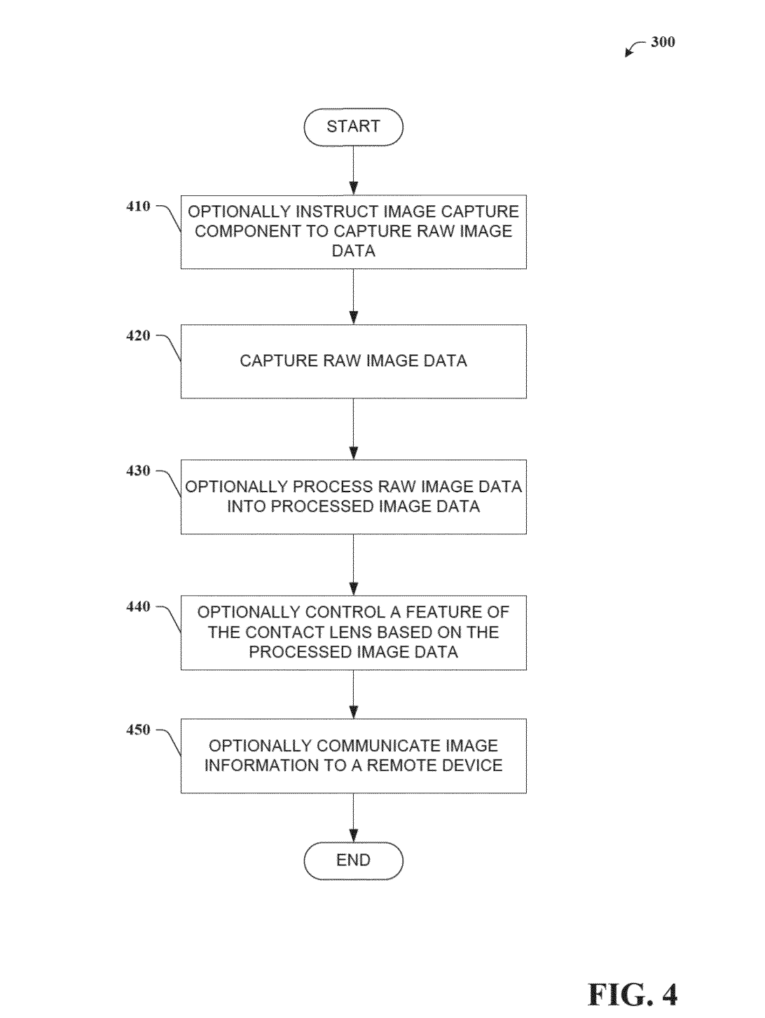

FIG. 4 illustrates various methodologies in accordance with certain disclosed aspects. While, for purposes of simplicity of explanation, the methodologies are shown and described as a series of acts, it is to be understood and appreciated that the disclosed aspects are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with certain disclosed aspects. Additionally, it is to be further appreciated that the methodologies disclosed hereinafter and throughout this disclosure are capable of being stored on an article of manufacture to facilitate transporting and transferring such methodologies to computers.

Referring to FIG. 4, an exemplary method 400 for capturing images corresponding to a scene in the gaze of a wearer of a contact lens is depicted. At reference numeral 410, an optional act of instructing an image capture component 210 to capture raw image data is performed (e.g. by an imaging control component 260, processing component 255, or control circuit 290). As noted above, it is to be appreciated that image capture component 210 can continuously or periodically measure the parameter with external instruction. At reference numeral 420, raw image data is captured corresponding to a scene in the gaze of a wearer of a contact lens (e.g. by an image capture component 210, image control component 260, processing component 255, or control circuit 290). At reference numeral 430, an optional act of processing the captured raw image data into processed image data is performed (e.g. by an analysis component 265, processing component 255, or control circuit 290). At reference numeral 440, an optional act of controlling a feature of the contact lens based on the processed image data is performed (e.g. by an analysis component 265, processing component 255, or control circuit 290). At reference numeral 450, an optional act of communicating image information (e.g., raw image data, processed image data, or commands related to raw image data or processed image data) to a remote device and/or receiving information from a remote device is performed (e.g. by an interface component 270 or control circuit 290).

Exemplary Networked and Distributed Environments

One of ordinary skill in the art can appreciate that the various embodiments described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the various embodiments of this disclosure.

FIG. 5 provides a schematic diagram of an exemplary networked or distributed computing environment. The distributed computing environment comprises computing objects 510, 512, etc. and computing objects or devices 520, 522, 524, 526, 528, etc., which may include programs, methods, data stores, programmable logic, etc., as represented by applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, tablets, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, network 540 may comprise other computing objects and computing devices that provide services to the system of FIG. 5, and/or may represent multiple interconnected networks, which are not shown. Each computing object 510, 512, etc. or computing objects or devices 520, 522, 524, 526, 528, etc. can also contain an application, such as applications 530, 532, 534, 536, 538, that might make use of an API, or other object, software, firmware and/or hardware, suitable for communication with or implementation of various embodiments of this disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any suitable network infrastructure can be used for exemplary communications made incident to the systems as described in various embodiments herein.

Thus, a host of network topologies and network infrastructures, such as client/server, peer-to-peer, or hybrid architectures, can be utilized. The “client” is a member of a class or group that uses the services of another class or group. A client can be a computer process, e.g., roughly a set of instructions or tasks, that requests a service provided by another program or process. A client process may utilize the requested service without having to “know” all working details about the other program or the service itself.

In a client/server architecture, particularly a networked system, a client can be a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc. provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances. Any of these computing devices may be processing data, or requesting transaction services or tasks that may implicate the techniques for systems as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network/bus 540 is the Internet, for example, the computing objects 510, 512, etc. can be Web servers, file servers, media servers, etc. with which the client computing objects or devices 520, 522, 524, 526, 528, etc. communicate via any of a number of known protocols, such as the hypertext transfer protocol (HTTP). Objects 510, 512, etc. may also serve as client computing objects or devices 520, 522, 524, 526, 528, etc., as may be characteristic of a distributed computing environment.

### Exemplary Computing Device

As mentioned, advantageously, the techniques described herein can be applied to any suitable device. It is to be understood, therefore, that handheld, portable and other computing devices and computing objects of all kinds are contemplated for use in connection with the various embodiments. Accordingly, the computer described below in FIG. 6 is but one example of a computing device that can be employed with implementing one or more of the systems or methods shown and described in connection with FIGS. 1-6. Additionally, a suitable server can include one or more aspects of the below computer, such as a media server or other media management server components.

Although not required, embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. Neither is the computing environment 600 be interpreted as having any dependency or requirement relating to any one or combination of components illustrated in the exemplary operating environment 600.

With reference to FIG. 6, an exemplary computing device for implementing one or more embodiments in the form of a computer 610 is depicted. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640, non-limiting examples of which can include a keyboard, keypad, a pointing device, a mouse, stylus, touchpad, touchscreen, trackball, motion detector, camera, microphone, joystick, game pad, scanner, or any other device that allows the user to interact with computer 610. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 660. The remote computer 660 may be a personal computer, a server, a router, a network PC, a peer device or other common network node, or any other remote media consumption or transmission device, and may include any or all of the elements described above relative to the computer 610. The logical connections depicted in FIG. 6 include a network 662, such local area network (LAN) or a wide area network (WAN), but may also include other networks/buses e.g., cellular networks.

As mentioned above, while exemplary embodiments have been described in connection with various computing devices and network architectures, the underlying concepts may be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the techniques described herein. Thus, embodiments herein are contemplated from the standpoint of an API (or other software object), as well as from a software or hardware object that implements one or more aspects described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the aspects disclosed herein are not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function (e.g., coding and/or decoding); software stored on a computer readable medium; or a combination thereof.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

It is to be appreciated that components and sub-components described and claimed herein are configured to perform respective functions, and can perform such functions. Accordingly, it is intended that implementation of these components and sub-components in connection with devices, systems, apparatuses and/or methods are intended to encompass not in operation but configured to perform such functions as well as in operation and configured to and/or actually performing such functions.

In order to provide for or aid in the numerous inferences described herein (e.g. inferring relationships between metadata or inferring topics of interest to users), components described herein can examine the entirety or a subset of the data to which it is granted access and can provide for reasoning about or infer states of the system, environment, etc. from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention is not to be limited to any single embodiment, but rather can be construed in breadth, spirit and scope in accordance with the appended claims.

What is claimed is:

1. A device, comprising:
a contact lens comprising:
a substrate;
at least one image capture component disposed on or within the substrate of the contact lens configured to generate raw image data corresponding to a gaze of a wearer of the contact lens; and;
a processing component disposed on or within the substrate and connected to the at least one image capture component, the processing component is configured to receive the raw image data from the at least one image capture component.

2. The device of claim 1, wherein the processing component further comprises an analysis component configured to generate processed image data from the raw image data.

3. The device of claim 2, wherein the analysis component is further configured to generate a warning based upon at least one object detected in the processed image data.

4. The device of claim 2, wherein the processed image data includes metadata related to one or more detected object in the raw image data.

5. The device of claim 2, wherein the processed image data includes metadata related to light detected in the raw image data.

6. The device of claim 2, wherein the processed image data includes metadata related to one or more colors or patterns of colors detected in the raw image data.

7. The device of claim 2, wherein the processed image data includes one or more images meeting a predefined size, resolution, fields, color palette, luminance, contrast, chrominance, brightness, frame rate, quantization, interlaced, progressive, aspect ratio, pixel density, bit rate, compression, dimension, angle, or view.

8. The device of claim 1, wherein the at least one image capture component includes a Fresnel lens for focusing.

9. The device of claim 1, wherein the at least one image capture component includes a thin variable lens for focusing.

10. The device of claim 9, wherein the thin variable lens comprises at least one liquid layer configured to be electronically adjusted amongst a plurality of refractive index values.

11. The device of claim 1, wherein the at least one image capture component includes a diffractive lens for focusing.

12. The device of claim 1, wherein the at least one image capture component includes a refractive lens for focusing.

13. The device of claim 1, wherein the at least one image capture component includes a complementary metal-oxide-semiconductor image sensor configured for employment in generating the raw image data.

14. The device of claim 1, further comprising an image control component configured to instruct, based upon image capture criteria, the at least one image capture component to generate the raw image data.

15. The device of claim 1, further comprising:
a power component disposed on the substrate configured to capture energy wirelessly and convert the captured energy to usable electric power; and
wherein at least one of the image capture component or processing component is configured to employ the usable electric power.

16. The device of claim 1, wherein the processing component further comprises an interface component configured to communicate with a remote device.

17. The device of claim 16, wherein the interface component transmits at least one of the raw image data or image information derived from the raw image data to the remote device.

18. The device of claim 16, wherein the interface component receives image capture criteria from the remote device, the image capture criteria includes at least one parameter related to instructing the image capture component to generate raw image data.

19. The device of claim 1, further comprising:
a display disposed on or within the substrate;
wherein the processing component is further configured to present on the display a peripheral view derived from the raw image data.

20. A method, comprising:
generating, by contact lens, raw image data corresponding to a gaze of a wearer of the contact lens; and;
storing the raw image data.

21. The method of claim 20, further comprising analyzing, by the contact lens, the raw image data to generate processed image data.

22. The method of claim 21, further comprising generating, by the contact lens, a warning based upon at least one object detected in the processed image data.

23. The method of claim 20, wherein the generating further comprises employing a thin variable lens having at least one liquid layer configured to be electronically adjusted amongst a plurality of refractive index values.

24. The method of claim 20, further comprising receiving, by the contact lens, image capture criteria from the host device, wherein the image capture criteria includes at least one parameter related to instructing the contact lens to generate raw image data.

25. The method of claim 20, further comprising:
generating, by the contact lens, a peripheral view based upon the raw image data; and
presenting, by the contact lens, the peripheral view on a display embedded on or within the contact lens.

26. A non-transitory computer-readable medium having instructions stored thereon that, in response to execution, cause a contact lens including a processor to perform operations comprising:
generating raw image data corresponding to a gaze of a wearer of the contact lens; and
storing the raw image data.

27. The non-transitory computer-readable medium of claim 26, further comprising analyzing the raw image data to generate processed image data.

28. The non-transitory computer-readable medium of claim 27, further comprising generating a warning based upon at least one object detected in the processed image data.

29. The non-transitory computer-readable medium of claim 26, wherein the generating further comprises employing a thin variable lens having at least one liquid layer configured to be electronically adjusted amongst a plurality of refractive index.

30. The non-transitory computer-readable medium of claim 26, further comprising receiving image capture criteria from the host device, wherein the image capture criteria includes at least one parameter related to instructing the contact lens to generate raw image data.

31. The non-transitory computer-readable medium of claim 26, further comprising:
generating a peripheral view based upon the raw image data; and
presenting the peripheral view on a display embedded on or within the contact lens.
